(19) United States
(12) Patent Application Publication
(10) Pub. No.: US 2013/0157004 A1
(43) Pub. Date: Jun. 20, 2013

(54) METHOD FOR SEALING PORES OF CERAMIC LAYER AND ARTICLE MANUFACTURED BY THE SAME

(71) Applicant: YONG-GANG ZHU, Shenzhen City (CN)

(72) Inventor: YONG-GANG ZHU, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/441,303

(22) Filed: Apr. 6, 2012

(30) Foreign Application Priority Data
Dec. 16, 2011 (CN) 201110423290.7

(51) Int. Cl. B32B 15/04; B05D 1/04

(52) U.S. Cl. 428/139; 427/447; 428/221; 428/339

(57) ABSTRACT

An article comprises a metal substrate, a ceramic layer formed on the metal substrate, and a sealing layer formed on the ceramic layer. The ceramic layer defines pores. The sealing layer comprises filling portions filling the ceramic pores. The filling portions contain thermosetting resins. A method for sealing pores of ceramic layer is also provided.

### BACKGROUND

1. Technical Field

The exemplary disclosure generally relates to a method for sealing pores of ceramic layers and an article manufactured by the method.

2. Description of Related Art

A thermal spraying process or an enamel manufacturing process may be used to form ceramic layers on metal substrates to give the substrates a ceramic appearance. However, the ceramic layers formed by prior art methods define a plurality of pores therein. The pores allow air and moisture to pass through and encourage corrosion of the metal substrates, or at least reduce the adherence of the ceramic layer.

Therefore, there is room for improvement within the art.

### BRIEF DESCRIPTION OF THE DRAWINGS

Many aspects of the embodiments may be better understood with reference to the following drawings. The components in the drawings are not necessarily drawn to scale, the emphasis instead being placed upon clearly illustrating the principles of the exemplary disclosure. Moreover, in the drawings, like reference numerals designate corresponding parts throughout the several views. Wherever possible, the same reference numbers are used throughout the drawings to refer to the same or like elements of an embodiment.

FIG. 1 is a cross-sectional view of an exemplary embodiment of a coated article.

FIG. 2 is a cross-sectional view of a substrate coated with a ceramic layer.

FIG. 3 is a cross-sectional view of a substrate coated with a sealing layer.

### DETAILED DESCRIPTION

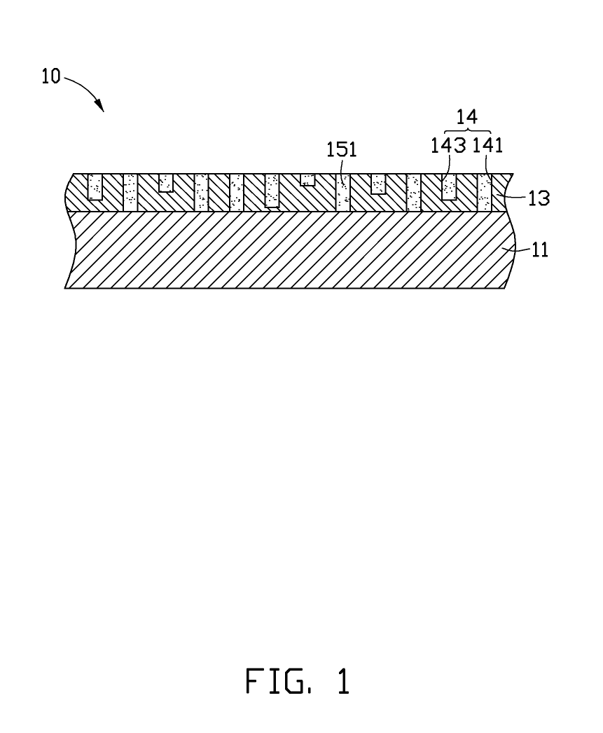

Referring to FIG. 1, an exemplary method for sealing pores of ceramic layer may include the following steps:

A metal substrate 11 is provided. The metal substrate 11 may be made of stainless steel, aluminum alloy, or magnesium alloy.

The metal substrate 11 is treated by a roughening process, such as sandblasting, etching, or the like. The roughening process can improve the bond between the metal substrate 11 and a layer on the top surface of the substrate 11. After roughening, The surface roughness (Ra) of the metal substrate 11 is about 1.3 μm to about 2.0 μm.

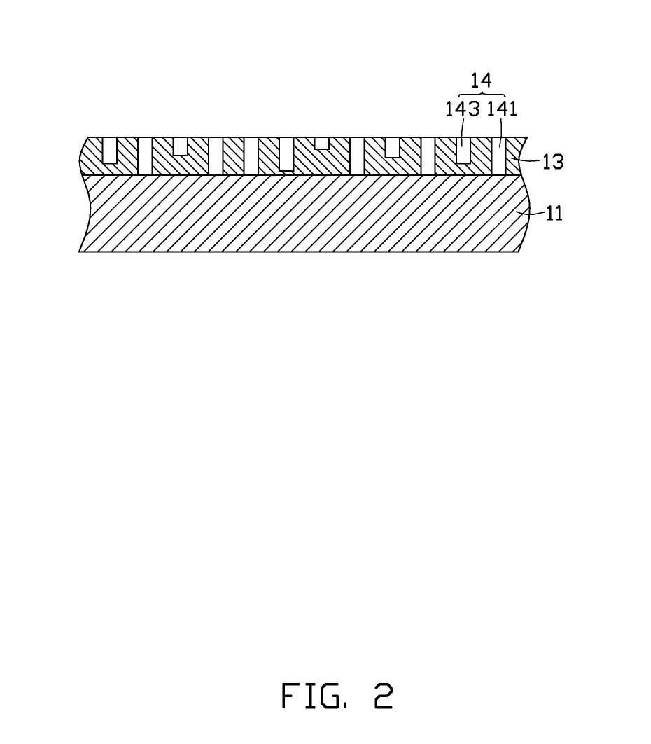

Referring to FIG. 2, a ceramic layer 13 is formed on the metal substrate 11 by flame spraying. A spraying powder used to form the ceramic layer 13 mainly consists of ceramic powder, such as metal oxidate, metal carbide and/or metal nitride powder. In the embodiment, the spraying powder is made of materials selected from a group consisting of titanium oxide, iron oxide, aluminium oxide, and zirconium dioxide. The ceramic layer 13 deposited defines a plurality of ceramic pores 14 therein. The ceramic pores 14 comprise a plurality of through pores 141 and a plurality of blind pores 143, and the percentage of through pores 141 may exceed 50%. The porosity of the ceramic layer 13 may be about 15% to about 30%. Some of the ceramic pores 14 can be macroscopic. The ceramic layer 13 has a thickness of about 0.12 mm to about 0.3 mm.

The ceramic layer 13 is ground to smooth the surface of the ceramic layer 13. In the embodiment, an abrasive band may be used to grind the ceramic layer 13.

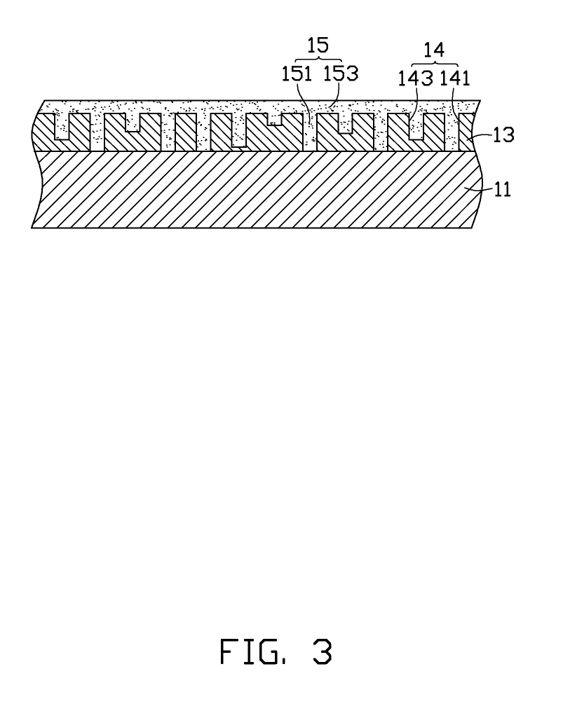

Referring to FIG. 3, a sealing layer 15 is formed on the ceramic layer 13 by electrostatic powder spray. The sealing layer 15 seals the ceramic pores 14. The method of forming the sealing layer 15 may include the following steps:

An electrostatic powder spray device (not shown) is provided. The device includes an electrostatic spray gun. A conventional sealing powder is also provided. A high voltage electric-field is applied to the substrate 11 and the electrostatic powder spray device. The substrate 11 is negatively charged. The sealing powder is positively charged and sprayed by the electrostatic spray gun to be adsorbed on the surface of the metal substrate 11. The substrate 11 is then baked at a temperature of about 170° C. to about 190° C. for about 10 min to about 15 min. During baking, the sealing powder melts and spreads evenly on the ceramic layer 13. After baking, the substrate 11 is cooled to solidify the molten sealing powder and form a sealing layer 15 on the ceramic layer 13. The sealing layer 15 has a thickness of about 0.02 mm to about 0.04 mm. The sealing powder mainly consists of thermosetting resin powder having high corrosion resistance, such as epoxy resin, a mixture of epoxy resin and polyester, a mixture of polyurethane and polyurethane, and a mixture of saturated hydroxyl polyester resin and polyurethane. The particles of sealing powder have a diameter of about 32 μm to about 100 μm.

The sealing layer 15 defines a plurality of filling portions 151 and a covering portion 153. The filling portions 151 fill the ceramic pores 14. The covering portion 153 is formed on the ceramic layer 13 and the filling portions 151. The sealing layer 15 prevents corrosion-promoting agents from entering and arriving at the metal substrate 11, thus improves the corrosion resistance of the substrate 11.

The substrate 11 having the sealing layer 15 may be polished to remove the covering portion 153 and expose the ceramic layer 13.

A color pigment can be added to the sealing powder to make the filling portions 151 the same color as the ceramic layer 13.

The polishing treatment is optional to the embodiment.

An exemplary embodiment of an article 10 subjected to the method includes a metal substrate 11 and a ceramic layer 13 formed on the ceramic layer 11. The ceramic layer 13 defines ceramic pores 14 therein. The ceramic pores 14 comprise a plurality of through pores 141 and a plurality of blind pores 143, and the percentage of through pores 141 may exceed 50%. The porosity of the ceramic layer 13 is about 15% to about 30%. Some of the ceramic pores 14 are macroscopic.

The ceramic layer 13 mainly consists of metal oxidate, metal carbide and/or metal nitride. In the embodiment, the ceramic layer 13 is made of materials selected from a group consisting of titanium oxide, iron oxide, aluminium oxide, and zirconium dioxide. The ceramic layer 13 has a thickness of about 0.12 mm to about 0.3 mm.

The article 10 further includes a sealing layer 15. The sealing layer 15 includes filling portions 151 and a covering portion 153. The filling portions 151 fill the ceramic pores 14. The covering portion 153 is coated on the ceramic layer 13 and the filling portions 151. The sealing layer 15 comprises a thermosetting resin composition having high corrosion resistance, such as epoxy resin, a mixture of epoxy resin and polyester, a mixture of polyurethane and polyurethane, and a mixture of saturated hydroxyl polyester resin and polyurethane.

### EXAMPLES

Experimental examples of the present disclosure are described as follows.

### Example 1

A sample of metal substrate 11 was made of stainless steel.

Forming a ceramic layer 13 on the metal substrate 11: the spraying powder used to form the ceramic layer 13 comprised titanium oxide powder having a mass percentage of about 13%. The ceramic layer 13 had a thickness of about 0.12 mm.

The ceramic layer 13 was ground by an abrasive band.

Forming a sealing layer 15 on the ceramic layer 13: a sealing powder was provided; the sealing powder was sprayed by a electrostatic spray gun to be adsorbed on the surface of the metal substrate 11; the substrate 11 was then baked at a temperature about 200° C. for 8 min. The sealing layer 15 had a thickness of about 0.04 mm, the sealing powder mainly consisted of epoxy resin. The particles of sealing powder had a diameter of about 32 μm to about 100 μm.

The sealing layer 15 includes filling portions 151 and a covering portion 153. The filling portions 151 fill the ceramic pores 14. The covering portion 153 is coated onto the ceramic layer 13 and the filling portions 151.

Polishing the sealing layer 15: a “500#” type alumina abrasive band was used to polish the sealing layer 15 to remove the covering portion 153.

### Example 2

A sample of metal substrate 11 was made of aluminum alloy.

Forming a ceramic layer 13 on the metal substrate 11: the spraying powder used to form the ceramic layer 13 comprised titanium oxide powder having a mass percentage of about 40%. The ceramic layer 13 had a thickness of about 0.18 mm.

The ceramic layer 13 was ground by an abrasive band.

Forming a sealing layer 15 on the ceramic layer 13: a sealing powder was provided; the sealing powder was sprayed by a electrostatic spray gun to be adsorbed on the surface of the metal substrate 11; the substrate 11 was then baked at a temperature about 180° C. for 15 min. The sealing layer 15 had a thickness of about 0.04 mm. The sealing powder mainly consisted of epoxy resin having a mass percentage of about 60%. The particles of sealing powder had a diameter of about 32 μm to about 100 μm.

The sealing layer 15 includes filling portions 151 and a covering portion 153. The filling portions 151 fill the ceramic pores 14. The covering portion 153 is coated onto the ceramic layer 13 and the filling portions 151.

Polishing the substrate 11: a “500#” type alumina abrasive band was used to polish the substrate 11 to remove the covering portion 153.

### Example 3

A sample of metal substrate 11 was made of stainless steel.

Forming a ceramic layer 13 on the metal substrate 11: the spraying powder used to form the ceramic layer 13 comprised aluminum oxide powder having a mass percentage of about 80%. The ceramic layer 13 had a thickness of about 0.14 mm.

The ceramic layer 13 was ground by an abrasive band.

Forming a sealing layer 15 on the ceramic layer 13: a sealing powder was provided; the sealing powder was sprayed by a electrostatic spray gun to be adsorbed on the surface of the metal substrate 11; the substrate 11 was then baked at a temperature about 200° C. for 10 min. The sealing layer 15 had a thickness of about 0.04 mm. The sealing powder was a mixture of saturated hydroxyl polyester resin and polyurethane, wherein the mass percentage of the polyurethane was about 60%. The particles of sealing powder had a diameter of about 32 μm to about 100 μm. The specific gravity of the sealing powder was about 1.4 g/cm² to about 1.8 g/cm².

The sealing layer 15 includes filling portions 151 and a covering portion 153. The filling portions 151 fill the ceramic pore 14. The covering portion 153 is coated onto the ceramic layer 13 and the filling portions 151.

Polishing the substrate 11: a “500#” type alumina abrasive band was used to polish the substrate 11 to remove the covering portion 153.

### Test Results

The article 10 of examples 1, 2 and 3 underwent salt spray testing, solvent resistance testing, and artificial sweat testing.

Salt spray test: providing a salt spray chamber, a sodium chloride solution having a mass percentage of about 5% was sprayed by the chamber onto the article 10 for about 2 hours. The temperature of the sodium chloride solution kept at about 35° C. Then the article 10 was located in a high-humidity room at 40° C., 93% RH for 168 hours. The articles 10 were subjected to 2 specific circular areas of the salt spray test. The tests indicated that no discoloration, cracking, or peeling occurred on the articles 10.

Solvent resistance test: the articles 10 were repeatedly wiped by a cotton piece with a force about 6 N to about 12 N, the frequency was 100 times per minute, the cotton piece was constantly impregnated with petroleum ether or isopropanol having a mass percentage of about 99.7%. The articles 10 were subjected to 2 hours of the solvent resistance test. The tests indicated that there was no discoloration.

Artificial sweat test: the artificial sweat test is similar with the solvent resistance test, except artificial sweat was used instead of the petroleum ether or isopropanol. The articles 10 were subjected to 2 hours of the artificial sweat test. The tests indicated no discoloration.

The articles 10 thus have good corrosion resistance, solvent resistance, and sweat resistance.

It is to be understood, however, that even through numerous characteristics and advantages of the exemplary disclosure have been set forth in the foregoing description, together with details of the system and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

1. An article, comprising:
a metal substrate;
a ceramic layer formed on the ceramic layer, the ceramic layer defining ceramic pores therein; and
a sealing layer formed on the ceramic layer, the sealing layer comprising filling portions filling the ceramic pores, the filling portions containing thermosetting resins.

2. The article as claimed in claim 1, wherein the porosity of the ceramic layer is about 15% to about 30%.

3. The article as claimed in claim 1, wherein the ceramic pores comprise a plurality of through pores and a plurality of blind pores.

4. The article as claimed in claim 1, wherein in the ceramic pores, the percentage of the through pores exceeds 50%.

5. The article as claimed in claim 1, wherein the ceramic layer has a thickness of about 0.12 mm to about 0.3 mm.

6. The article as claimed in claim 1, wherein the ceramic layer mainly consists of metal oxidate, metal carbide and/or metal nitride.

7. The article as claimed in claim 6, wherein the ceramic layer is made of materials selected from a group consisting of titanium oxide, iron oxide, aluminium oxide, and zirconium dioxide.

8. The article as claimed in claim 1, wherein the sealing layer is made of materials selected from a group consisting of epoxy resin, a mixture of epoxy resin and polyester, a mixture of polyurethane and polyurethane, and a mixture of saturated hydroxyl polyester resin and polyurethane.

9. The article as claimed in claim 1, wherein the sealing layer further comprises a covering portion coated on the ceramic layer and a filling portion.

10. A method for sealing pores of ceramic layer comprising:
providing a metal substrate;
flame spraying a ceramic layer on the metal substrate, the ceramic layer defining ceramic pores therein;
electrostatic powder spraying a sealing layer on the ceramic layer, the sealing layer comprising filling portions filling the ceramic pores, a sealing powder used to form the filling portions containing thermosetting resins.

11. The method of claim 10, wherein the sealing layer is formed by the following steps: the sealing powder is adsorbed on the surface of the metal substrate and the ceramic pores; the metal substrate is baked at a temperature about 170° C. to about 190° C. for about 10 min to about 15 min.

12. The method of claim 10, wherein the particles of sealing powder has a diameter of about 32 μm to about 100 μm.

13. The method of claim 10, wherein the sealing powder is made of materials selected from a group consisting of epoxy resin, a mixture of epoxy resin and polyester, a mixture of polyurethane and polyurethane, and a mixture of saturated hydroxyl polyester resin and polyurethane.

14. The method of claim 10, wherein the method further comprises a step of roughening the metal substrate before forming the ceramic layer.

15. The method of claim 14, wherein the surface roughness (Ra) of the metal substrate is about 1.3 μm to about 2.0 μm.

16. The method of claim 10, wherein the sealing layer further comprises a covering portion coated on the ceramic layer and a filling portion.

17. The method of claim 10, wherein the method further comprises a step of polishing the sealing layer to remove the covering portion and exposes the ceramic layer.
